(19) United States
(12) Patent Application Publication
(10) Pub. No.: US 2013/0036354 A1
(43) Pub. Date: Feb. 7, 2013

(54) MUSIC INTERFACE

(71) Applicants: Boris Itskov, Markham (CA); Peter Guterres, Markham (CA)

(72) Inventors: Boris Itskov, Markham (CA); Peter Guterres, Markham (CA)

(21) Appl. No.: 13/497,953

(22) PCT Filed: Sep. 21, 2010
(86) PCT No.: PCT/CA10/01452

§ 371 Date: Oct. 19, 2012

(30) Foreign Application Priority Data
Sep. 23, 2009 (CA) 2680336

(51) Int. Cl. G06F 3/01

(52) U.S. Cl. 715/716

(57) ABSTRACT

The music selection system allows a game terminal to use the logic processing and information of a remote computer server to provide fast relevant search results based on user keyed information. The search is carried out in parallel using different databases to provide possible results which are then combined and reduced by the server. This arrangement provides fast accurate results and advantageously uses search techniques well known to users. This familiarity in combination with the specialized databases provides relevant music search results with relatively few keystroke entries.

### FIELD OF THE INVENTION

The present invention relates to a music interface that allows a user to enter a series of letters with a search procedure providing search results of possible interest based on a number of predetermined music specific criteria.

### BACKGROUND OF THE INVENTION

The traditional jukebox interface forces a user to enter different search criteria to allow the device to provide a number of choices and present to the user a series of display screens to narrow the search results. This search approach of forcing a user to enter a number of restrictions and choices allows the interface to function with a reduced hard drive space and within CPU power capabilities that can be carried out by the device in a suitable time. Typically the search results are carried out by the device without the benefit of real time communication with outside data sources.

Users are familiar with typical search engines where a series of key words are entered that allow a user to effectively search a database. Google© and Yahoo© search-type capabilities are extremely well known, however this type of search capability has not been extended to game devices and jukeboxes that allow the selection and play of music in a public place.

The present invention provides an effective interface for a user to easily carry out searches and select music to be played in an effective manner.

### SUMMARY OF THE INVENTION

A music selection system of the present invention is particularly suited for playing of music in a public establishment and includes a music selection search function. The system comprises a computing arrangement with a communication function for accessing at least one remotely located computer server using a public communication network where the at least one computer server includes a plurality of databases specific to musical selections for play and transmission to the computing arrangement. The music selection search function provides a search screen for entry of keyed letters and any entered keyed letters are provided to the at least one remotely located computer server. The at least one remotely located computer server uses the plurality of databases and the provided keyed letters to provide the computing arrangement with possible music selections that match the keyed letters in combination with known criteria associated with the music selection system. The computer arrangement includes a display screen for presenting a limited number of possible matches and any possible match can be selected for play.

According to an aspect of the invention, the music selection system includes the function to automatically update the search results with additional entered information on a continuous basis.

In an aspect of the invention, the presented possible matches provide choices to further narrow the search criteria and if selected, providing the choice to the at least one server and subsequently provide further choices as required until a musical record is selected for play.

### BRIEF DESCRIPTION OF THE DRAWINGS

Preferred embodiments of the invention are shown in the drawings, wherein:

FIG. 1 illustrates a display screen that is used by a combination game terminal and music selection terminal typically used in a public establishment;

FIG. 2 illustrates a further display screen where the music search option has been initiated and the display screen provides a data entry line and a series of results are shown as the user enters the letters;

FIG. 3 is a display screen providing additional search results which have been narrowed using one of the original search results selected by the user;

FIG. 4 is a further display screen showing a particular musical selection “Wonderful Tonight” that is the desired selection in combination with a further series of suggestions based on like music and also presenting other music of the particular artist;

FIG. 5 is a schematic of the logic used by the music interface to provide relevant search results; and

FIG. 6 is a schematic of the logic used by the remote computer server.

### DETAILED DESCRIPTION OF THE PREFERRED EMBODIMENTS

A music interface is used by JVL Corporation in the game terminal and music interface sold under the ENCORE trademark. This terminal allows players to play games and/or order music.

In the earlier system, a game terminal for a public establishment is shown that additionally allows a user to select music for play in the establishment. The game terminal allows contact with a remote server having a large digital library of music to be selected for play. This server preferably streams the music to the terminal or to a further device at the particular location for play in the establishment.

One such server that is capable of streaming music is MEDIA NET DIGITAL.

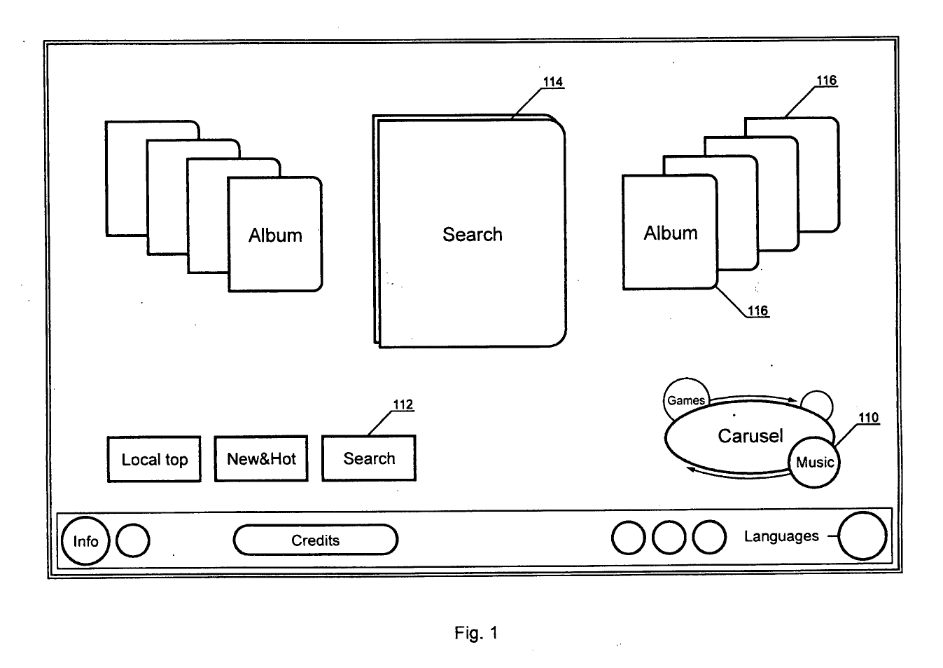

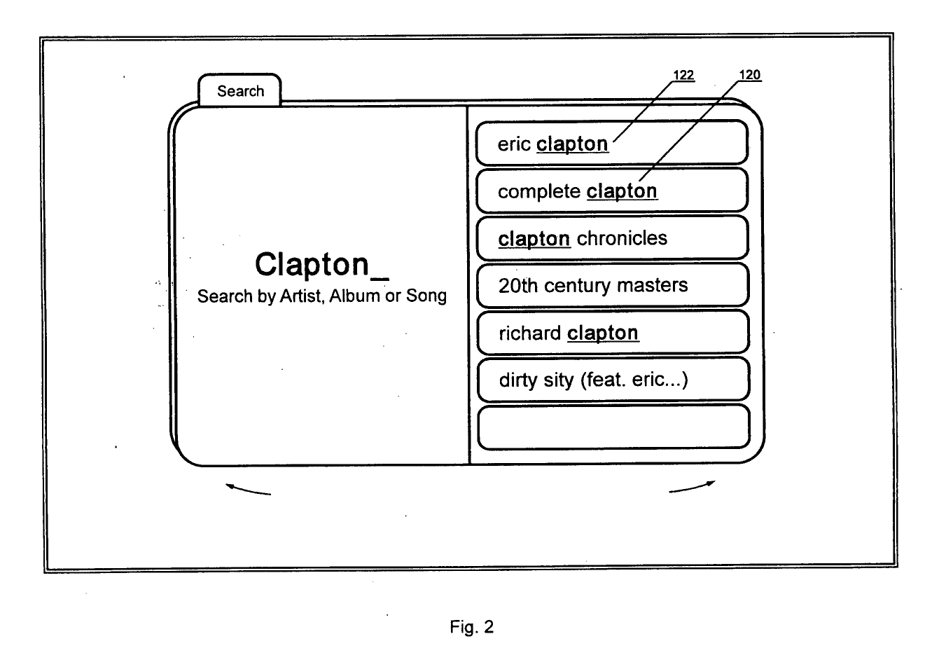

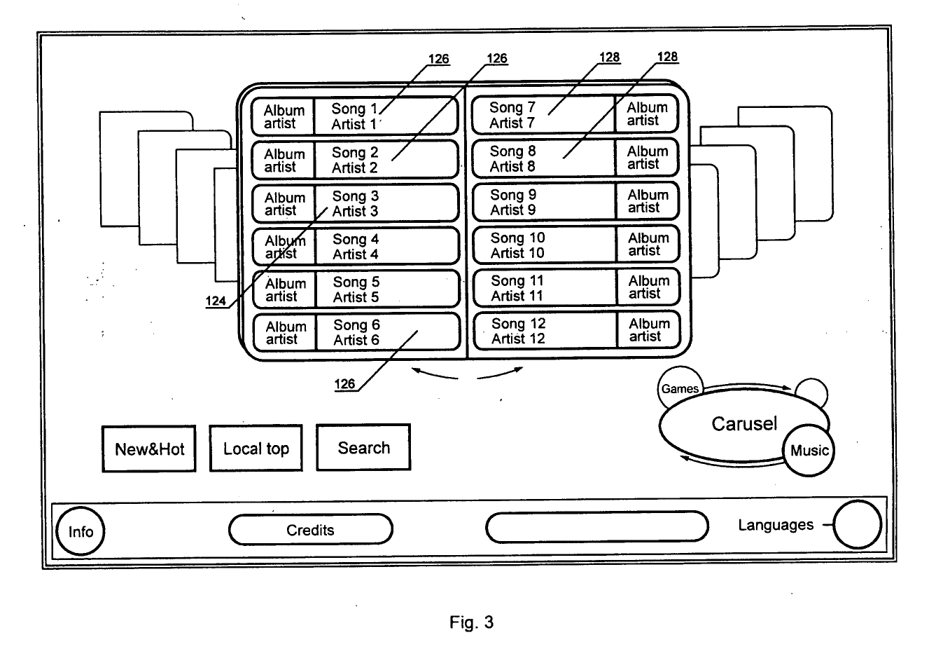

The search engine used in the present music interface preferably uses a touch screen input to select music from the options of “Music”, “Games” and “Tournaments”, followed by touching the search icon 112. The display screen of FIG. 1 is provided on the terminal and the user is either presented with the search option 114 shown centrally on the screen or can browse within the series of different genres indicated as 116. The touch screen input allows convenient selection of any of these icons to commence the search. In the example, the general search criteria 114 is touched and the user is presented the display screen of FIG. 2. The user has started to enter the letters to spell “Clapton” and the search engine immediately produces a series of results that are shown at 120 based on the data string that has been entered. The left side of the data screen shows or provides instructions that the user could search by “Artist”, “Album” or “Song”. Entering of the word “Clapton” has produced six results which are displayed on the right of the screen. Those results include albums, artists and songs related to the search string entered by the users. The type of the result is indicated by the icon to the right of the result. The user has executed selection 122 by touching this particular search result. The user is then presented with the display screen of FIG. 3 and a series of results are shown on the left and right hand side of the screen. When the selection 122 is an Artist, such as Eric Clapton, the results are songs of Eric Clapton.

The particular order of Eric Clapton songs and the particular Eric Clapton song 124 displayed to the left side of the screen are only based on certain criteria that have been maintained in the database and as part of the search logic. At the present point, the user has merely entered the word “Clapton” and touched the selection “Eric Clapton” and the search then produces the results as shown in FIG. 3.

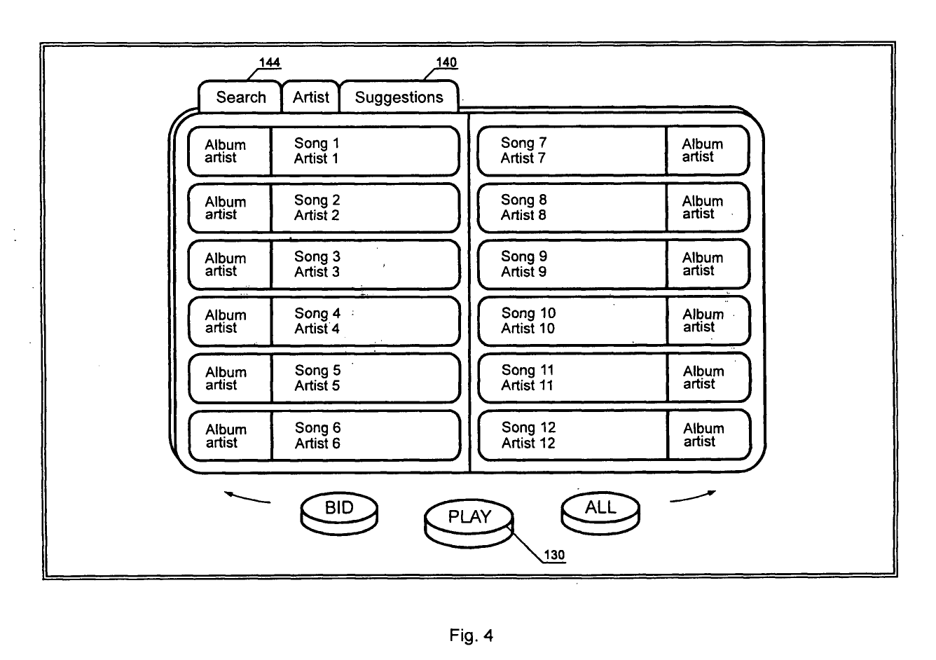

In FIG. 4 the user has touched the selection “Wonderful Tonight—Eric Clapton” and if this is the particular selection he desires, he can execute the play button 130. When the player selected a song “Wonderful Night” the suggestion tab 140 was added and a series of songs are presented as possible suggestions. If the player decides that one of these suggestions are preferred to the previously selected “Wonderful Tonight” then that particular selection will be prominently displayed and highlighted and the remaining field filled with suggestions generated by the system. These suggestions preferably take into account players' selections previously found, location preferences perhaps using the songs most often played at the location or other suitable approaches to deliver location tailored results (example country theme night club). If these results are not helpful to the user, the user can re-execute or touch the tab “Eric Clapton” and return to the earlier results. When the user executes multiple selections in a row, each of those selections will generate a set of suggestions displayed on the interface. User can navigate between those subsequent suggestion screens by touching arrows <not marked on fig> below the results.

The user at any time can also execute the Search tab 144 and return to enter additional key words into the string. A new series of search results are produced with the additional information as soon as the first letter of the next key word is entered.

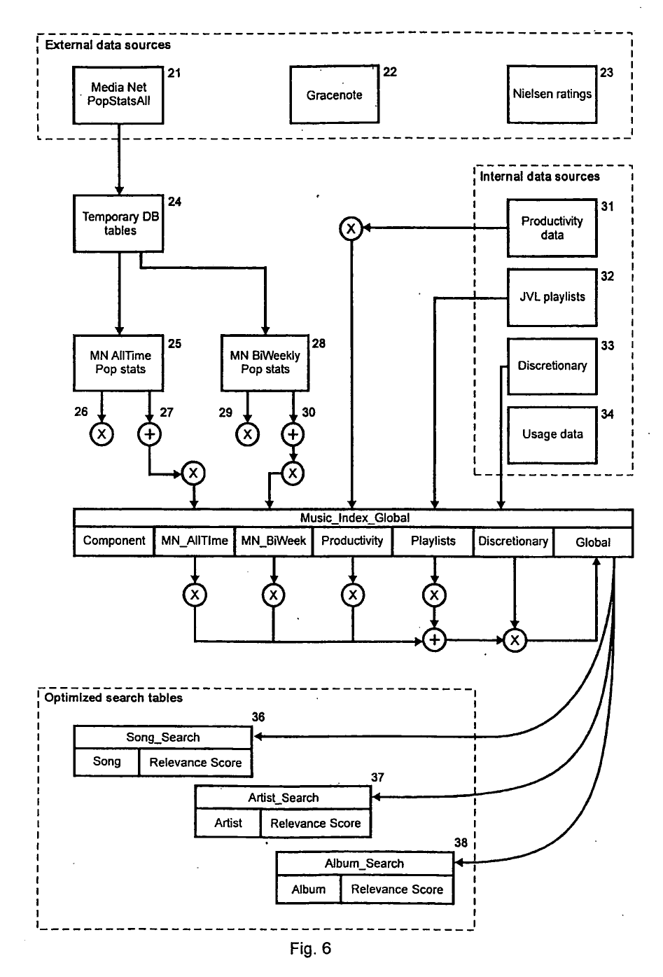

The search logic preferably used in the present system is shown in FIG. 6. The user input is indicated as 1, and this would include the sequence of letters typed into the search field. This information is then simultaneously processed by album query 2, the artist query 3, the song query 4, the combined song/artist query 5, and a phonetic query by artist 6. Various scores are provided from these results and the scores are sorted by relevancy. This step is accomplished at element 7. The results of various queries are effectively combined into a common result pool. Duplicate entries (for example the same song published in different albums) are eliminated by filter algorithm 9. Another algorithm that is indicated at 10 picks final set of results by applying variety of criteria in addition to relevance score. In a preferred embodiment it requires that minimum of 3 matching results of a different kind are included (3 artists, 3 albums and 3 songs). The result list is then produced at 11 and displayed on screen in a suitable manner.

The logic for producing relevance scores is shown in FIG. 7. A series of external data sources are accessible and indicated as 21, 22 and 23. These data sources are used to import the data into temporary database tables indicated as 24. The server process analyzes the data in tables 24 to extract popularity statistics. This processing is specific to the data source. In the preferred embodiment, the data provided by Media Net are processed to generate popularity statistics in two temporal scopes: all-time (stored in 25) and bi-weekly (stored in 28). The all time scope favors established artists well into their career, while bi-weekly scope catches current music trends.

The system also includes a number of internal data sources indicated as 31, 32, 33 and 34. Those data sources are used to extract additional relevancy information. Productivity data 31 is defined as total number of songs published by the artist. It emphasizes well established artists and is also useful to increase relevancy of new releases by such artists. The set of JVL playlists 32 represents the body of music that has been selected by an expert as the most appropriate for target audience of coin operated game and music machines. Every song and artist that is included on those playlists is given additional relevancy score. Discretionary data 33 allow music editor to fine tune the system to balance performance of various artists. The usage data 34 provides popularity statistics for songs ordered on JVL network.

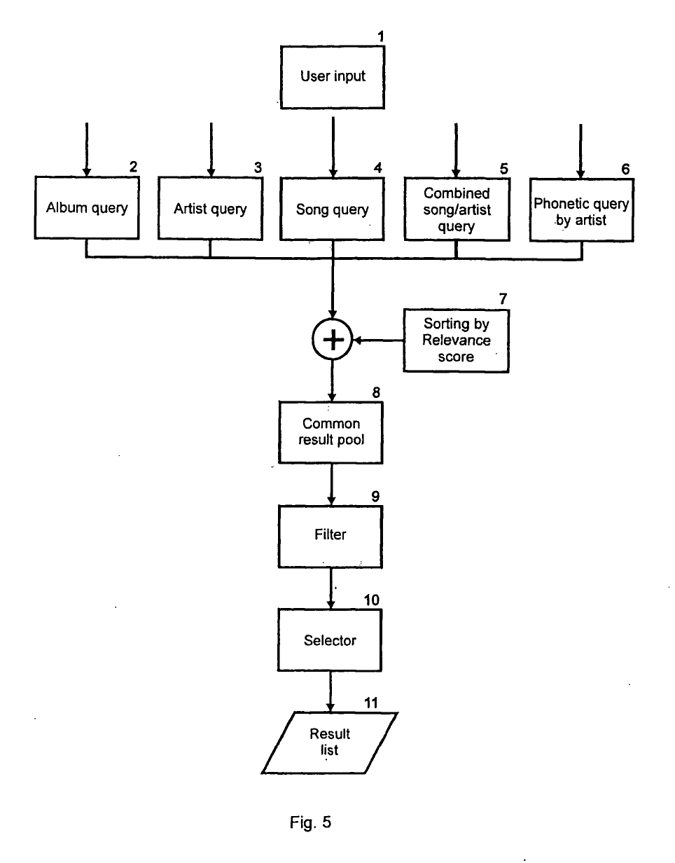

All of the relevancy components thus calculated are put into a Music_Index_Global table 35. Additional process combines all of those components using weights set by music editor into one global relevancy score. That relevancy score is copied into a set of tables optimized for execution of specific queries described on FIG. 5, 36 for song search, 37 for artist search and 38 for album search.

The present system shows 9 possible search results, however the number of results can be increased or decreased according to the terminal's capabilities or the preference of the operator.

The search logic for the present system can include phonetic equivalent databases, and this helps to address problems associated with misspelling and alternate pronunciations of words. This interface assumes certain aspects of the search string being entered by the user and this is possible in that each of the queries is executed against several databases. This information is combined with other information such as the location or the actual user and thus the system can take into account preferences of the user and/or location and/or time for example.

Details of one implementation of this system in combination with additional features are shown in appendix A that follows.

### APPENDIX A

The search is interactive, as soon as the first letter is entered the request should be processed by the server. Each request preferably executes 3 queries (against artists, songs and albums) and returns up to 9 results sorted by combined Relevancy score. The queries that handle albums and artists use word based matching, meaning that the sequence of letters entered by the users will be compared with the beginning of every word in the appropriate record in the database. For example the artist The Notorious B.I.G. can be found by entering “Notorious”. Song titles are found by direct match of the string entered by the users to the beginning of the song title. Each result could be an artist or an album or a song, which is indicated by an appropriate icon on the interface.

An additional query is used in situations where the full name of the song is too common and top 9 results are not sufficient to help the user find what they are looking for. For example, search for “Rain” would return 764 songs and even if they are sorted by popularity the chances are the song player is looking for will not make it into 9 entries presented on the interface. The additional query allows players to further refine their search by adding artist name to the search—in free format, Google style. In our example, after seeing that “Rain” is not sufficient the player can enter the name of the artist after the name of the song, i.e. Rain Prince.

To support this functionality, that additional query is activated when the first letter of the second word is entered by the player. The query will interpret the second word of the entry field as the name of the artist and search for results which match first word with the name of the song (the same way it is done currently) and the second word with the name of the artist. Results of that further query will be added to the pool of the results returned by the first three queries and sorted by combined popularity score. The song query would continue to be executed with each character entered by the player so if the player was actually looking for the song where “Rain” is only a first word, this query will provide more meaningful results than the combined song/artist query. To handle situation when player enters multi-word song name and then artist name, the last word of the entry is considered as the name of the artist.

With experience, more queries will be introduced to return intelligent results regardless of the order or format of player's entry (i.e. if artist's name was entered first), deal with typos and misspellings.

A user is expected to continue to enter characters until they see what they are looking for in the list of results. At the same time we will give players ability to see all of the results in current search by adding button “Show all” to the interface. This may help players who are not sure of the name or spelling of the artist to find what they are looking for. Once this button is touched remaining results of the search are retrieved from the server and presented on the number of pages inserted into the binder. Retrieval of those results is divided into groups and uses server side cache.

Search state should be held for the duration of “user session”. User session starts when player deposits money into the machine or logs in. Once the money is spent and a specified period of inactivity passes, the session ends and search state should be cleared.

The following basic metrics may be used by the search engine to sort search results in a meaningful way:
Artist productivity—the number of songs published by the artist. As MediaNet treats the same song published in different albums as the same entity, this metric will include all of the recordings.
Song popularity—the number of time the song has been requested. This number can be obtained from different sources
   Gracenote
   MediaNet
   Nielsen ratings
   JVL (locality scope)
   JVL (global scope)
Where available, popularity will be calculated in two temporal scope—short term (for example 2 weeks) and long term (all available records); and
Presence of song on the playlist.

All metrics will be updated on a daily basis, when data feed from MediaNet is imported into the database.

Several combined scores will be calculated based on those basic metrics. Each of the scores is suited for sorting of a specific component (song, album, artist) and there will be a separate formula for each of them. Exact coefficients for each of the metrics in the formula are determined by the music editor based on expert evaluation of search results:
Artist. The score for artist is calculated as the sum of Productivity plus combined Popularity of artist's songs
The score for an album is calculated as combined Popularity of the songs in the album
The score for a song is calculated using Popularity metrics.

Formulas for combined scores are selected in such a way that results of different kind can be sorted among themselves using their combined scores. I.e. the server executes multiple queries (against artist, album and song list plus combination thereof) and obtains up to 9 results from each query. Results are then joined together, sorted by the score value and top 9 results are sent to the client.

The new music User Interface includes a number of scrollable binders, representing playlists developed by the company. See FIG. 1.

The number of company prepared playlists will be reduced to approximately 30, representing 16 standard genres by AMG classification and most popular themes. In addition to those static playlists, two dynamic playlists will be provided—Local top and New and Hot. Those dynamic playlists will be updated daily on the server (real-time update and ability to reset totals will be considered for Local top). All playlists are sorted alphabetically. We will consider giving player ability to change sorting order through the UI.

Some of the genres will have further breakdown by decade. For example Rock section will have “All time” with 100-200 entries and additional playlists of similar depth for each of the relevant decades. Those playlists, for example, can be visually separated by tabs in the binder. Player starts in “All time” tab by default and can scroll through this section and move into the next available decade tab, such as “50s” and touch tabs to move between the sections of the playlist.

The system makes a default selection of playlists for operator when the music is first installed on location based on geo-location of the operator and song popularity in the geographical vicinity of that location. The Operator will have the option to change that selection at any time.

When a song is selected by the player, additional tab “Suggestions” is inserted into the binder. The song touched by the player is displayed most prominently there and the rest of the tab is filled by suggestions generated by Gracenote engine. Those suggestions should take into account player's selection and location preferences using top 5 songs played on this location or other suitable method to deliver location tailored results. At the same time “Play” button is displayed on the interface giving player ability to order a song. If player clicks on one of the suggestions on the list, the new selection is moved to a prominent position and new list of suggestions is generated. Suggestion results are delivered to the UI in asynchronous fashion, so the interface remains responsive and fluid all the time. Player's preferences, based on previous history of that player and/or playlists created by the player can be taken into account. This feature requires player identification either via explicit login, a RFID tag or other identification approaches.

Search is represented as one of the binders for player selection. An additional shortcut on the interface can be provided. When Search binder is opened, players see their entry line in the left pane, virtual keyboard below the binder and results in the right pane. Result list can contain artist, albums and songs and is not scrollable. Player is expected to enter enough characters to see what they are looking for in the results pane.

Clicking on one of the results should lead to
For songs—Suggestion tab is inserted with touched song prominently displayed and ready to be played (see 0 above)
For Albums—tab with tracks of the album is inserted into the binder. That tab will contain as many pages as required to show album's content. Songs should be sorted by popularity.
For Artists—tab with list of songs by the artist should be inserted into the binder with identical song names filtered out. The songs could be sorted
   By popularity
   Alphabetically
   In a combination view, where 10 of the most popular songs are shown at the top and then all of the songs are shown in an alphabetical order. Combination view should make visual distinction between featured 10 songs and the rest of the list
      Preferably the player has the ability to change sorting option with a simple, easy to understand control.

In game mode, while using game selection menu players are shown the title of current song and name of the artist scrolling through the info bar. Touching this text or dedicated button should display “Playing now” pop-up screen, showing currently playing song and the list of 10 previously played ones. Additionally this screen could include artist suggestions, location favorites etc.

In game mode, while playing the game, players should see the name of the currently playing song, as well as some system generated suggestions in a discrete pop-up window at the top of the screen. When players touch this pop-up, the game is paused and full-size “Playing now” pop-up screen appears. Players have ability to opt out of this feature.

In demo mode, the game demos should be shown in a reduced format, leaving an L-shaped area to promote music. This area should display content similar to in-game pop-up window, but on a larger scale.

In music mode the title of current song and name of the artist scrolls through the info bar. Touching this bar opens another binder that contains list of 10 previously played songs, suggestions and similar content.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A music selection system for play of music in a public establishment and including a music selection search function, said system comprising
a computing arrangement with a communication function for accessing at least one remotely located computer server using a public communication network;
said at least one computer server including a plurality of databases specific to musical selections for play and transmission to said computing arrangement;
said music selection search function providing a search screen for entry of keywords and any entered keywords or portions thereof are provided to said at least one remotely located computer server;
said at least one remotely located computer server using said plurality of databases and said provided keywords to provide to said computing arrangement possible music selections that match the keywords in combination with known criteria associated with the music selection system;
said computer arrangement providing a display screen for presenting a limited number of possible matches and any possible match can be selected for play.

2. A music selection system as claimed in claim 1 including automatically updating search results with additional entered information on a continuous basis.

3. A music selection system as claimed in claim 2 including within said presented possible matches providing interim choices to further narrow the search criteria and if selected, providing the interim choice to said at least one server and subsequently providing further interim choices as required until a musical record is selected for play.
